(19) United States
(12) Patent Application Publication
(10) Pub. No.: US 2006/0065232 A1
(43) Pub. Date: Mar. 30, 2006

(54) Engine and method of generating power

(76) Inventors: Michael Wurtz, Hamburg (DE); Jan-Hinnerk Scheel, Grosshansdorf (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/235,595

(22) Filed: Sep. 26, 2005

(30) Foreign Application Priority Data
Sep. 24, 2004 (DE) 10 2004 046 683.1

(51) Int. Cl. F02B 53/00; F01C 1/00

(52) U.S. Cl. 123/204; 418/241; 418/137

(57) ABSTRACT

In an engine comprising a compression unit, an expansion unit and a connecting structure disposed between the compression and expansion units and also means for supplying energy to the engine, wherein the connecting structure includes an air inlet area for receiving compressed air from the compression unit and an air outlet area for appropriating gas to the expansion unit, the connecting structure includes a gas volume which is delimited by the compression unit in the air inlet area and by the gas expansion unit in the air outlet area and the gas in the expansion unit is expanded to a pressure corresponding essentially to the pressure of the ambient air.

### BACKGROUND OF THE INVENTION

The invention relates to an engine comprising a compression unit, an expansion unit and a connecting unit with an air inlet area and a gas outlet area and to a method of generating power.

The state of the art comprises many engine concepts based on the principle of utilizing the forces effective during the expansion of gases which have been compressed to high pressures. Examples of such engine concepts are piston engines such as spark ignition engines, Diesel engines, the Wankel engine and also gas turbines. In all these engine concepts, the gas pressure is first increased by a compression and a temperature increase achieved by compressing the gas for example in a cylinder of a piston engine by a reduction of cylinder volume or, in the gas turbine by compression of the gas in a compressor stage. The gas is heated either by a pulsed combustion at the time of maximum pressure of the gas as for example in a piston internal combustion engine or by a continuous combustion of a fuel as it occurs in a gas turbine.

Both concepts have certain disadvantages which detrimentally affect the efficiency of the engine or, respectively, the utilization of the energy released during the combustion. This is true for piston engines because in each cycle an air fuel mixture is supplied to the cylinder and is compressed in the cylinder and then ignited and expanded whereupon all the gas present in the cylinder is discharged and the cycle has to be repeated all over again with fresh, cold gas. After expansion, the gas is discharged at a certain residual pressure which however remains unutilized.

In gas turbines, no closed constant volume is provided for a cycle. Rather, air is compressed and supplied to a combustion chamber where it is heated by continuous combustion of fuel which results in a volume increase of the air. The air is then expanded and discharged from the combustion chamber at high speed. In the combustion chamber, the gas pressure remains constant. In small gas turbines without heat exchanger however, the efficiency is less than 20%. All these systems require a multitude of parts and have a relatively low efficiency in the utilization of the energy released during the combustion of the fuel.

It is therefore the object of the present invention to provide an engine and a method of generating power which is based on a new and more efficient concept.

### SUMMARY OF THE INVENTION

In an engine comprising a compression unit, an expansion unit and a connecting structure disposed between the compression and expansion units and also means for supplying energy to the engine, wherein the connecting structure includes an air inlet area for receiving compressed air from the compression unit and an air outlet area for appropriating gas to the expansion unit, the connecting structure includes a gas volume which is delimited by the compression unit in the air inlet area and by the gas expansion unit in the air outlet area. The connecting structure preferably has between the compression unit and the expansion unit an essentially constant gas volume. The gas in the expansion unit is expanded to a pressure corresponding essentially to the pressure of the ambient air.

This engine concept is based on the principle of adding energy to a compressed gas disposed in a closed space of essentially constant volume disposed in the connecting structure. The energy may be added in the form of heat but also in another suitable manner such as the addition of additional air or gas.

If energy is added in the form of heat use is made of the fact that the specific heat capacity (cₚ, cᵥ) of air measured at a constant volume (cᵥ) is lower by 40% than if measured at constant pressure (cₚ). Consequently, the addition of energy in a constant volume results in a greater increase in the temperature of the gas volume than it would if the gas volume would be increased. A temperature increase of a gas in a constant volume also results in a pressure increase if the gas volume is closed and the gas cannot escape.

Some piston engines such as the Diesel engine do not have a constant volume during combustion. Because of the relatively slow combustion of the fuel, the Diesel engine combustion is almost isobar, that is, it occurs with essentially constant pressure. This is different in gas turbines where no closed gas volume is provided for the combustion. Instead, there is a constant gas volume flow into the combustion space of the gas turbine where a constant fuel combustion takes place. The gas pressure in the combustion space remains constant.

Since, because of the high specific heat capacity cᵥ, the heating of a gas in a constant volume is particularly efficient, in the engine according to the invention, a particularly efficient gas pressure increase in a closed gas volume is obtained.

In connection with the invention, the gas volume comprises the gas volume of the connecting structure plus the air or gas volume in the compression unit and the expansion unit which is in communication with the volume of the connecting structure and is not separated therefrom. The air inlet area is the transition area between the compression unit and the connecting structure; the gas outlet area is the transition area between the connecting structure and the expansion unit. An air inlet area and gas outlet area may extend into the compression and, respectively, the expansion unit as far as they are in open communication with the connecting structure.

In an engine according to the invention, the gas volume comprises particularly air or possibly, a mixture of air and combustion residues of the fuel or added air or gas and is limited in the air inlet area by the compression unit and in the gas outlet area by the connecting structure so that the gas volume in the connecting structure is completely enclosed and essentially no gas or air can escape.

A compression unit is a device which is suitable for the compression of gas such as a piston or rotary compressor. An expansion unit may be a turbine, for example, an axial or a radial turbine or another device which utilizes the forces available during the expansion of high-pressure gas such as piston systems or other types of compressors when used in a reversed principle.

In a particular embodiment of the invention, a heating device may be provided in, or at, the connecting structure. Preferably, the heating device is a fuel combustion unit which includes a fuel supply line and a combustion nozzle particularly for a continuous or a pulsed combustion of the fuel. This advantageous embodiment provides for a direct and therefore particularly efficient input of energy in the form of heat into the gas volume present in the combustion chamber. Alternatively, heat may be added in other ways for example by heating coils or heat exchangers disposed within the heating space or on the outside thereof or by a heat bath. Furthermore, the gas pressure in the connecting structure may be increased by the addition or air or gas to the air supplied by the compression unit.

Since the combustion or, respectively, heating of the gas takes place in a closed volume, selectively a continuous or pulsed combustion is possible. However, with a continuous combustion, the wear of needed ignition devices is substantially lower than it is with pulsed combustion. As combustion processes low speed detonation, catalytic combustion or heat conversion also in connection with a fuel cell or a heat exchanger may be used.

In a particular embodiment of the engine according to the invention, the compression unit is designed for the inclusion of an air volume. Furthermore, the compression unit is designed for the compression of the enclosed air volume and the compressed air volume can be joined with gas in a gas volume in the connecting structure. This embodiment has the advantage that pre-compressed air not used in the gas volume can be supplied to the combustion process without opening the gas volume so that a loss of gas density in the connecting structure will not occur. The admitted air has preferably the same density as the gas in the gas volume in the connecting structure but it has a lower temperature and a lower pressure since it is compressed without the addition of heat.

In connection with the invention, the air volume after joining the gas volume in the connecting structure is added to the gas volume in the inlet area of the connecting structure.

In a further embodiment of the engine according to the invention, the expansion unit is designed for separating and including a gas amount from the gas volume in the connecting structure. This has the advantage that exhaust gas is conducted out of the gas volume without opening the gas volume.

In a particularly advantageous embodiment of the engine according to the invention, the gas amount, upon separation from the gas volume, has essentially the same volume as the air amount upon jointure with the gas volume. The addition of air amounts to the gas volume and the separation of gas amounts from the gas volume in the connecting structure occurs in cycles and at the same frequency. This has the advantage that the total volume of the gas in the connecting structure including the transition areas in the compression unit and the expansion unit remains essentially constant and also that the mass of the gases in the total volume remains constant over many cycles, that is an essentially constant mass flow is established. In this way, a particular effective volume-constant heating of the gas in the connecting structure is facilitated. To be included with a combustion however are small amounts of combustion products which must be discharged in addition to the amount of air introduced.

It is particularly advantageous if the volume of the air and gas amounts in the compression and expansion chambers are smaller than the gas volume in the connecting structure so that in each cycle only a part of the gas is replaced. In this case, variations of the volume are small with respect to the total volume when the cycles of the compression and expansion units are not exactly synchronized so that the total gas volume is still essentially constant.

It is also within the scope of the invention, that the air amount has a volume different from that of the gas amount. In this case, a uniform mass flow is obtained in that the joining and separating cycles occur with different speed or, respectively, frequency.

Such an embodiment has the advantage that the dimensioning is flexible for different purposes if for example different design concepts for the compression and expansion units are to be realized. Furthermore, the formation of undesirable standing waves in the gas volume are prevented in this way.

If, in a further embodiment of the engine according to the invention, the expansion unit is provided for the expansion of the gas amount volume and if a device is provided for the utilization of the force effective during expansion of the gas amount, advantageously, the pressure difference between the high gas pressure of the gas in the connecting structure generated by compression and heating and for example the normal pressure of the ambient air can be utilized for other purposes such as for example the generation of electricity or the operation of mechanical devices. This can be done for example by driving a piston with a connecting rod or a rotational body arranged in a housing section asymmetrically surrounding the rotational body.

Such an engine operates particularly with the utilization of the effect that, with the high gas pressure achieved with the supply of energy in the connecting structure, an expansion ratio in the expansion unit is achieved which is greater than the compression ratio in the compression unit. The achievable expansion ratio is the ratio of the volume of a gas amount before the expansion to the volume after expansion and the drop of the gas pressure to the ambient pressure. The compression ratio is the volume ratio of an air amount before and after compression. Without the addition of energy, the achievable expansion ratio without the generation of a vacuum during the expansion would, even under ideal conditions, equal the compression ratio. However, because of friction losses, it would actually be even smaller.

For example, in piston engines such as gasoline engines, the expansion ratio, by design necessity, equals the compression ratio because compression and expansion occur in the same cylinder. About at the point of the highest compression energy is added in the form of a combustion whereby the gas pressure on the piston is greatly increased. However, during expansion only the same expansion ratio is obtained as in the preceding compression because of the limited stroke of the piston so that an unused residual excess pressure remains.

In a further development of the engine according to the invention, an arrangement for driving the compression unit for the compression of the air amount by at least part of the power generated during the expansion of the gas amount in the expansion unit is provided. This is particularly advantageous because another drive for driving the compression unit is then not needed. This is achieved by uncoupling of energy—depending on the type of the compression unit and the expansion unit—for example by drive rods, V-belts or similar structures, but also by the generation of electricity for intermediate storage or directly driving an electric motor.

An advantageous embodiment of the invention resides in an arrangement for the synchronization, particularly an alternating synchronization of the jointure of the air amount volume and the gas volume and the separation of the volume of the gas amount from the gas volume. In the context of the invention, alternating synchronization means that the jointure of the air amount with the gas in the gas volume and the separation of the gas amount from the gas volume in the connecting structure occurs essentially at the same time. Since with such a synchronization the air amount is joined with the gas volume at a point in time when an equally large gas amount is separated from the gas volume of the connecting structure the overall volume of the gas chamber remains essentially constant. In this way, a more efficient utilization of the combustion energy for an increase of the gas temperature and the gas pressure is achieved.

The ideal synchronization depends on operating conditions, that is the flow rate of the mass flow, the ratios of the volumes of the air amount, the gas amount and the volume of the gas chamber of the connecting structure and also on the intensity of the energy supply in the connecting structure. In this respect, it is particularly advantageous if the synchronization of the working cycles of the compression unit with the inclusion of the compressed air amount, the joining of the air amount with the gas in the gas chamber of the connecting structure and the working cycles of the expansion unit, namely the inclusion of a air amount and the separation of the gas amount occur with the same frequency, but the phases of the working cycles of the compression unit and expansion unit are changeable relative to each other. If the expansion unit is a rotating device, a phase shift can be achieved for example by means of a controllable angle adjustment of the rotating element about the axis of rotation thereof. With an electronic control for an electric drive motor for the compression unit a phase shift can be achieved in a particularly simple way.

If in an embodiment of the engine according to the invention, the compression unit comprises a first rotational element which is arranged particularly in a housing section and if the first rotational element includes radial slots in which blade elements are radially movably received a particularly simple and compact design is obtained. The slots receiving the blade elements are arranged at uniform distances along the circumference of the rotational element. The housing section is preferably integrally formed with the housing of the connecting structure so that a sealed transition between the compression unit and the connecting structure is realized. It is furthermore preferred if the housing section around the rotational element is curved with a center of curvature which is spaced from the axis of rotation of the rotational element.

Preferably, the compression unit is so designed that the air amount is enclosed between two adjacent first blade elements, the outer wall of the first rotational element and the inner wall of the housing section. In this particularly simple way, a cyclical enclosure of air amounts is obtained which can be moved by the rotation of the rotational element and their containment between the housing section, the rotational element and the adjacent blade elements.

The center of curvature of the housing section is preferably spaced from the axis of rotation of the rotational element to such a degree that, during rotation of the rotational element, the volume of the enclosed air amount is reduced because it is moved to an area in which the distance between the inner wall of the housing section and the outer wall of the rotational element becomes smaller. For the inclusion of the air amount in the compression unit, it is furthermore necessary that the blade elements are abutting the side walls and are sealed with respect to the side walls.

In a particular embodiment of the invention mechanical or electrical means are provided for the rotational angle dependent control of the radial movement of the first blade elements. This is achieved in that the blade elements move radially outwardly in their support slots of the rotation element so that they abut the inner wall of the housing section. In this way, the air amount is sealingly enclosed. Mechanical means for controlling the radial movement of the first area elements are for example guide rails or lever systems; electrical control means are for example rotational angle-controlled electric motors.

In a preferred embodiment of the invention, the expansion unit comprises a second rotational element which is arranged in a second housing section. Analogous to the above-mentioned case of the compression unit, it is also in this case advantageous that the second rotational element is provided with radial slots in which second blade elements are radially movably supported, and that the gas amount is enclosed after separation by two adjacent blade elements, an outer wall of the second rotational element and an inner wall of the second housing section. Also in this case, the housing section is formed preferably integrally with the housing of the connecting chamber and the blade elements are in sealing contact with the side walls of the housing section.

In contrast to the arrangement described earlier for the compression unit, the expansion unit has a housing section wall with a curvature which is so selected that the distance between the inner wall of the housing section and the outer surface of the rotational body increases during the rotation of the rotational element. Consequently, also the volume of the enclosed gas amount increases. This has the advantage that the expansion of the gas heated in the heating chamber causes rotation of the second rotational element. Because of the pressure increase in the gas chamber and a possible expansion to ambient pressure, an expansion ratio is obtained which is higher than the compression ratio.

With the same arguments as made with respect to the compression unit, also for the motor according to the invention, particularly mechanical or electrical means may be provided for the rotational angle-dependent control of the radial movement of the second blade elements. The arrangement corresponds to that described for the compression element.

With a first or a second rotational element in the compression and, respectively, the expansion unit, the two rotational elements may be interconnected for common rotation possibly in a releasable manner. This may be achieved by being mounted on a common shaft or by a V-belt drive. In this way, excess power generated during expansion of the gas amount in the expansion unit is utilized for the compression of the air amount in the compression unit.

If the torques resulting from the pressure differences between the gas pressure in the connecting structure and the ambient air pressure outside the compression or, respectively, expansion unit and effective on the first and second rotational elements are directed in opposite directions and are essentially equal, it is advantageous that the expansion of the gas in the expansion unit does not need to act against a torque difference between the rotational units. For an adjustment of the torques effective on the first and second rotational elements, the effective areas of the area elements in the air inlet and the gas outlet areas as well as the distances thereof from the axes of rotation of the first and second rotational elements are suitably selected. The term “effective area” in connection with the present invention refers to the part of the surface of a blade element which extends from the circumference of a corresponding rotational element and which delimits an air or gas volume.

In a preferred embodiment of the engine according to the invention, the first rotational element in the compression unit is driven by the second rotational element in the expansion unit. This has the advantage that no separate drive for the rotational element in the compression unit is needed.

In another advantageous embodiment, the compression unit of the engine according to the invention is provided with a pre-compression unit arranged in series with the compression unit. In this way, the total torque acting on the first rotation element is effectively reduced and the energy gained by the combustion in the heating chamber and uncoupled in the expansion unit is effectively utilized and less of it is consumed for driving the first rotational element in the compression units than would be used without the pre-compression stage.

The object of the invention is further solved by an engine comprising a compression unit with means for the inclusion of an air amount, an expansion unit and a means for introducing energy wherein the expansion ratio in the expansion unit is greater than the compression ratio in the compression unit. In such an engine, the pressure of air or gas which is contained in a compression unit and which has been compressed in the compression unit can be increased by the addition of energy. With respect to the type of the energy addition and the energy supply medium, reference is made to the earlier description. The air or, respectively, gas pressure, which is increased over the pressure generated in the compression unit in accordance with the compression ratio by the introduction of energy, provides for an expansion ratio in the expansion unit which is greater than the compression ratio in the compression unit.

In one advantageous embodiment of the invention, the energy supply means is arranged in the expansion unit of the engine.

If, for example, a part of the energy uncoupled during the expansion of the air, or respectively, the gas in the expansion unit of the engine according to the invention is utilized for the operation of the compression unit and there is an excess amount of energy the excess energy can be used for other purposes as described above. Alternatively, the energy can be supplied to the cycle in the expansion unit.

The object of the present invention is furthermore solved by a power generation method including the following steps:

Enclosing an air amount in a compression unit,

Compressing the air amount by reducing the volume of the air amount in the compression unit,

Joining the volume of the air amount with a gas volume in a connecting structure,

Mixing the air amount with gas contained in the connecting structure,

Increasing the pressure in the connecting structure,

Separating a gas amount from the gas in the gas volume of the connecting structure and enclosing that separated gas amount in an expansion unit,

Expanding the gas amount in the expansion unit and utilizing the power generated by the expansion of the gas amount in the expansion unit.

This power generation method describes essentially the process steps occurring in the engine according to the invention. Also, with this power generation method, a gas can be continuously heated in an essentially constant closed gas volume to which a limited amount of fresh air is added and in which limited gas amounts are enclosed and from which combustion gas is removed. Also with the power generation method according to the invention, the gas in the closed connecting structure is heated particularly effectively and the gas pressure is accordingly effectively increased. The above explanations concerning the engine according to the invention are applicable correspondingly to a power generation method. The same is true for the definition of the gas volume.

In a preferred embodiment of the power generation method according to the invention, the gas pressure in the connecting structure is increased essentially by heating of the gas. The gas is preferably continuously heated in the connecting structure which provides for particularly simple energy addition in a compact structure. For the compensation of pressure oscillations however the gas in the connecting structure may also be heated in a pulsed manner. It is particularly preferred if the gas is heated in the connecting structure by combustion of fuel. This provides for direct and therefore particularly effective heat input.

In order to obtain an advantageous constant mass flow of added air and separated gases, the masses of air and gas added to, and respectively, removed from, the connecting structure are to be essentially the same. In this connection, it has to be taken into consideration that, with a combustion in the connecting structure, also the combustion products of the fuel introduced in the connecting structure must be removed which generally represents only a small part of the air and gas amounts. The same is true if the energy is added to the connecting structure in the form of compressed air.

In a preferred embodiment of the power generating method according to the invention, the method steps reducing volumes of air amounts in the air inlet area and increasing the gas volume in the gas inlet area and separating gas volumes in the gas outlet area occur at the same speed and such that the gas volume of the air inlet area, the gas volume in the transition area and that in the gas outlet area remains essentially constant.

In order to ensure the smallest possible variation of the gas pressure in the heating or gas chamber during a cycle, the volumes of the air amount during jointure with the gas volume and the gas amounts upon separation of the gas volume are smaller than the gas volume in the connecting structure. In particular, they are less than 50% of the gas volume and preferably less than 30% of the gas volume. In this way, in each instance only a small part of the gas in the connecting structure is replaced, which has the advantage that pressure variations are only a fraction of the maximum pressure. Preferably, gas pressure variations in the gas volumes are less than 50% of the maximum gas pressure in the connecting structure and preferably less than 30% of the maximum gas pressure.

In order to ensure continued operation of the power generating method, the method steps of the power generation procedure are cyclically repeated, and two or more of the method steps are executed at the same time, particularly the enclosing of the air amount, the compression of the air amount, the heating of the gas in the connecting structure and/or expansion of the gas amount.

Below the invention will be described in greater detail on the basis of embodiments of the invention with reference to the accompanying drawings without limitation of the general inventive concept. With respect to individual features of the invention not described in detail, reference is specifically made to the drawings.

### BRIEF DESCRIPTION OF THE DRAWINGS

FIG. 1 shows schematically, in a cross-sectional view, an embodiment of the engine according to the invention,

FIG. 2 shows schematically the power generating process according to the embodiment shown in FIG. 2,

FIGS. 3a to 3d show schematically the time-based succession of the positions of the air and gas volumes for the embodiment disclosed,

FIGS. 4a to 4c shows the gas pressure in the air amount, in the gas volume in the heating chamber, and the closing and opening conditions of the first and second area of the example on a time basis, and

FIG. 5 shows the thermodynamic process in principle for a gasoline engine comparison with an engine according to the present invention in a P-V diagram.

### DETAILED DESCRIPTION OF A PARTICULAR EMBODIMENT

In the following description functionally identical part are designated in the various figures by the same reference numerals.

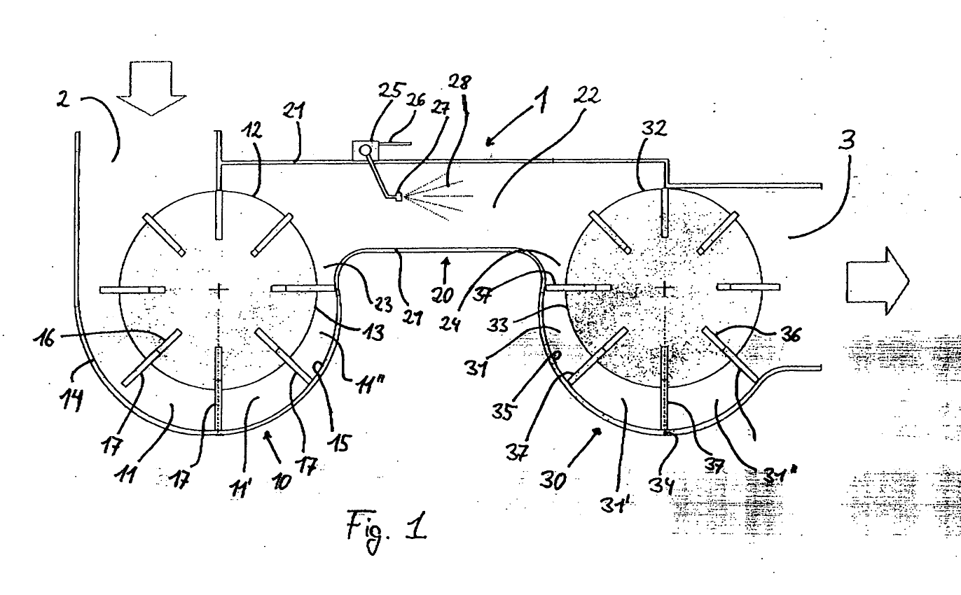

FIG. 1 shows schematically a particular embodiment of the motor 1 according to the invention. As indicated by an arrow, air is conducted via an air inlet 2 to a compressor unit 10 which is shown in the form of a rotational compressor. The rotational compressor 10 comprises a housing section 14, a rotational element 12 with radial slots 16 and first blade elements 17 radially movably disposed in the radial slots 16. The first blade elements 17 are for example lamellas, rigid plates or similar structures and sealingly abut the housing section 14 and the side walls of the housing section 14 so that enclosed air volumes 11, 11′, 11″ are formed. The axis of rotation of the first rotational element 12 is disposed with respect to the center of curvature of the housing section 14 so that, in the inlet area 2, the distance between the inner wall of the housing section 14 and the outer wall 13 of the rotational element 12, which, in the arrangement as shown in FIG. 1, rotates counterclockwise, is larger than in the air inlet area 23 to the gas chamber 22.

The volume of the air amounts 11, 11′, 11″ enclosed between the inner wall 15 of the housing section 14 of the compression unit 10, the outer wall 13 of the first rotational element 12 and the blade elements 12 is transported by rotation of the first rotational element 12 from the air inlet 2 toward the air inlet area 23 of the gas volume 22 of a connecting structure 20, that is, from 11 via 11′ to 11″ whereby the density as well as the temperature and the pressure of the air amounts 11, 11′, 11″ are increased.

Upon further rotation of the first rotational element 12, the volume of the air amount 11″ opens into the connecting structure 20. Then the air inlet area 23 of the gas volume 22 extends from the interior 21 of the gas volume 22 of the connecting structure 20 into the compression unit 10 up to the first blade element 17 delimiting the air amount 11″ toward the rear.

At the connecting structure 20, a combustion unit 25 with a fuel supply 26 is provided and an injection nozzle 27 is disposed in the interior 21 of the connecting structure. The combustion of the fuel results in a flame 28 in the gas volume 22 whereby the gas in the interior of the connecting structure 20 is heated. Also other means for supplying energy to the gas volume 22 may be provided such as catalytic heating processes, explosions, or heating coils supplied with electric power for example by fuel cells or a compressed air supply line.

The gas exit area 24 of the gas volume 22 includes an expansion unit 3 which in this embodiment is in the form of a slide blade pump operated in a reversed sense. The expansion unit 30 comprises a curved housing section 34, a second rotational element 32 with radial slots 36 and second blade elements 37 radially movably supported in the radial slots wherein the axis of rotation of the second rotational element 32 is displaced with respect to the center of curvature of the housing section 34 of the expansion unit 30. The second rotational element 32 rotates in the example shown in FIG. 1 counterclockwise. In the process, cyclically, gas amounts 31, 31′, 31″ are separated from the gas volume 22 and rotate the rotational body 32 so that they move—while expanding—toward the outlet 3.

Since the gas volume 22 is fully separated and enclosed by the chamber wall of the housing structure 21 and the outer walls of the first and second rotational element 12, 32, as well as the effective surfaces of the first and second blade elements 17, 37 in the compression unit 10 and, respectively, the expansion unit 30, the gas volume is heated largely in an isochore way—that is, at a constant volume 22 including the respective transition areas 23, 24. As a result, a particularly effective conversion of the energy release during combustion to an increased temperature and pressure of the gas present in the connecting structure 20 is achieved.

The displacement of the axis of rotation of the second rotational element 32 with respect to the center of curvature of the housing section 34 of the expansion unit 30 is so selected that, upon rotation of the rotational element 32, the volumes of the enclosed gas amounts 31, 31′, 31″ become larger with the rotation of the second rotational element 32 (31, 31′, 31″). In the shown embodiment, the gas amounts 31, 31′, 31″ are released after a rotation of about 135° through the outlet 3 in a direction as indicated by an arrow. The expansion ratio realized in the expansion unit 30 is greater than the compression ratio in the compression unit 10.

The operational principle of the engine according to the invention is based essentially on the isochore temperature and pressure increase of the gas volume 22, whereby a gas pressure is generated which is substantially above the ambient air pressure at the inlet 2 and the outlet 3. The pressure difference provides for rotational moments (torques) effective on the first and the second rotational elements 12, 32 in opposite directions. On the first rotational element 12, the moment is effective opposite to the direction of rotation; at the second rotational element 12 the moment is effective in the direction of the rotation thereof (both rotate counter clockwise). Second contributions to the moments which are effective on the first and second rotational element 12, 32 and which have the same directions as the contributions of the pressure differences result from the pressure in the air amounts 11, 11′, 11″, 31, 31′, 31″, which generate in the compression unit 10 a moment in clockwise direction and, in the expansion unit 30, a moment in counter-clockwise direction. Because of the higher pressure in the gas amount than in the air amount a higher expansion ratio can be obtained.

The excess power generated in the expansion unit 30, because of the—in comparison to the air pressure in the compression unit 10—higher gas pressure and the higher expansion ratio obtained thereby is utilized partially for the compression of air in the compression unit 10 and partially otherwise, for example, by generators or other suitable equipment connected to the second rotational element 32.

The compression occurs adiabatically, that is, without further energy input, so that an enclosed air amount 11, 11′, 11″ has, in the position 11″, that is shortly ahead of the jointure of the volume of the air amount 11′ with the gas volume 22, the same density as the gas in the gas volume 22, but a lower pressure and a lower temperature. Upon further rotation of the first rotational element 12, the volume of the air amount 11″ comes into open communication with the gas volume 22 whereby the air amount 11″ mixes with the gas. Since the volume of the air amount 11″ is small in comparison with the gas volume 22, the pressure and temperature of the gas in the gas volume 22 drops only moderately whereas the gas density remains constant. Because of the pressure equalization local density variations occur shortly in the air inlet area, which however do not influence the average gas density in the gas volume 22.

After jointure of the volume of the air amount 11″ with the gas volume 22, the air amount 11′ and the gas in the gas volume 22 intermix. During rotation of the first rotational element 12 in the compression unit 10, the volume of the air inlet area 23 becomes smaller (previously 11) which is delimited by the next blade element 17. At the same time, the gas volume 22 in the gas outlet area 24 becomes larger by the rotation of the second rotational element 32 into the expansion unit 30. The reduction of the gas volume 22 in the input area 23 in the compression unit 10 and the increase of the gas outlet area 24 into the expansion unit 30 balance each other so that, inspite of the rotation of the first and the second rotation element 12, 32 the gas volume 22 remains essentially the same over a cycle.

For driving the first rotational element 12 in the compression unit 10 by the rotation of the second rotational element 32 in the expansion unit 30, the first and second rotational elements 12, 32 are joined for example by a shaft or a V-belt. Also, the first rotational element 12 may have a separate drive such as an electric motor wherein the energy for driving the separate drive may be derived from the energy generated during the expansion of the gas amounts 31, 31′, 31″ in the expansion unit 30.

Depending on the operating conditions, the rotational moments effective on the rotational elements 12, 32 may need to be turned which may be achieved in that the synchronization of the rotation of the rotational elements is phase shifted such that the effective surface of the blade elements 17, 37 is increased, or, respectively decreased. By the tuning of the rotational moments which are effective on the first and the second rotational element 12, 32, it can be prevented that sudden high pressure differences or, respectively, pressure peaks develop and act on the blade elements 17, 37, whereby their wear would be increased or they even could break.

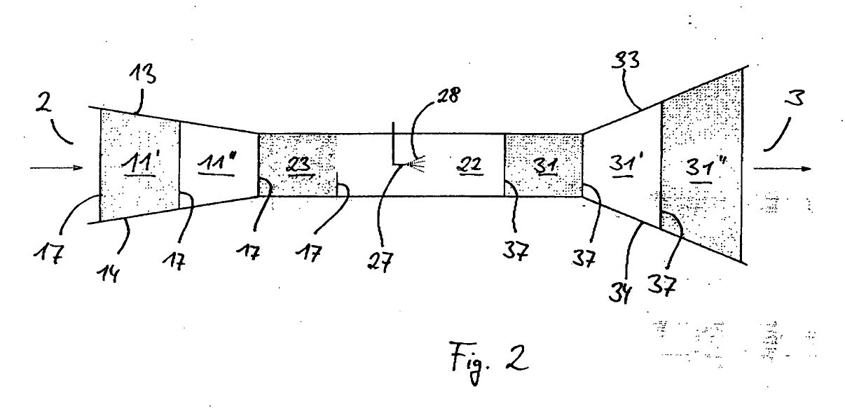

FIG. 2 shows schematically the process occurring in the engine 1 as shown in the exemplary embodiment of FIG. 1. In an inlet 2 air enters the engine as indicated by an arrow and an air amount 11′ is enclosed between the outer wall 13 of the rotational element 12 and the inner wall 15 of the housing section 14 of the compression unit 10 and between two first blade elements 17.

During rotation of the first rotational element 12, the enclosed air amount 11′ is compressed as indicated by the reduced size of the space 11″. In the embodiment shown in FIG. 1, this is achieved by rotation into an area in which the distance between the outer wall 13 of the first rotational element 12 and the inner wall 15 of the housing section 14 of the compression unit 10 is smaller than in the inlet 2. The angle between the lines representing the surface 13 of the rotational element 12 and the housing section 14 are a measure for the compression ratio.

As soon as the first blade element 17, which is the front most blade element in the direction of rotation of the rotational element 12, reaches the connecting structure 20, the volume of the air amount 11′ is opened thereby forming the inlet area 23 for the gas volume 22 in the connecting structure 20 as indicated by the partially retracted first blade element 17. The compressed air in the air amount 11″ rapidly mixes with the gas volume 22 so that the gas volume 22 compresses also the air inlet area 23 within a short period.

In the gas volume 22, combustion takes place with fuel supplied through a nozzle 27 forming a flame 28, which continuously heats the gas volume 22. On the outlet side of the gas volume 22, there is a gas amount 31, which has the temperature pressure and density of the gas in the gas volume 22 and which is enclosed in the expansion unit 30 by two second blade elements 37. In the course of rotation of the second rotational element 22, the gas amount expands as represented by the increased areas 31′ and 31″ as the rotation of the rotational element 32 moves the gas amount 31 to an area in which the distance between the outer surface 33 of the second rotational element 32 in the inner wall 35 of the housing section 34 becomes larger. The expansion ratio which is greater than the compression ratio is represented by the angle between the limiting lines 33, 34 which is greater than that of the compression unit 20. At the end of the expansion length, the volume of the gas amount 31″ opens toward the outlet 3, so that the gas is discharged in the direction of the arrow for example to an exhaust structure or a heat exchanger.

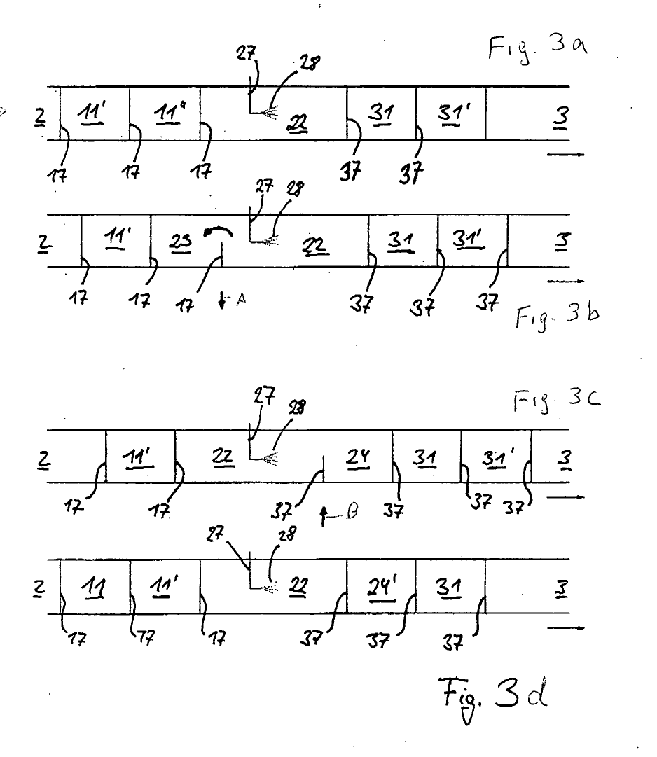

FIGS. 3a to 3d show the time-based progression of the air amounts 11, 11′, 11″, of the gas volume 22 and the gas amounts 31, 31′, 31″ as well as the closing and opening states of the first and second blade elements 17, 37. The representation corresponds to that of FIG. 2, but the symbolic representation of the compression and expansion in the compression unit 10 and in the expansion unit 30 were omitted for clarity reasons. The compression and expansion occur in the manner as described earlier.

FIGS. 3a to 3d shows the engine at various states. In the first representation (3a), the engine state is shown upon separation of the gas amount 31 from the volume 22 and before the jointure of a volume of an air amount 11″ with the gas volume 22. An air amount 11′ is already enclosed and an air amount 11″ has been moved, after having been enclosed, up to the air inlet area 23 of the gas volume 22 while being compressed so that this air amount 11″ has the same density but a lower temperature and a lower pressure than the gas in the gas volume 22, which is continuously heated by a nozzle 27 with a flame 28. In the direction of the arrow downstream of the connecting structure 20 a gas amount 31 with a density, temperature and pressure of the gas in the gas volume 22 has been enclosed between two adjacent blade elements 37. Another enclosed gas amount 31′ has been transported under adiabatic expansion to the position 31′.

In the next step as shown in FIG. 3b, the air amounts 11′, 11″ have been further moved so that the first blade element 17, which had separated the air amount 11″ from the gas volume 22 is retracted as symbolized by an arrow pointing downwardly. As a result, the volume of the air amount 11″ becomes a part of the inlet area 23. Gas from the gas volume 22 flows, because of its higher pressure, into the inlet area 23 and mixes with the air contained therein. For a short moment therefore the gas density is increased. In the expansion input 30, the enclosed gas amounts 31, 31′ have been moved further toward the outlet 3 while being expanded. The gas volume 22, following the rotation of the second blade element 37, has moved somewhat into the expansion unit 30.

In the following step as represented in FIG. 3c, the air has been fully mixed with the gas volume 22 and the enclosed air amount 11′ has been further moved toward the connecting structure 20. At the outlet of the heating chamber 21, a second blade element 37 is being inserted as indicated by the arrow pointed upwardly for enclosing the gas amount in a closed zone in a gas outlet area 24, in which the gas is still in communication with the gas of the gas volume 22 and also has the same properties. The enclosed gas amounts 31, 31′ have been further transported toward the outlet 31.

FIG. 3d shows the state after closing of the second blade element 37. This state is, in principle, the same engine state as that shown in FIG. 3a. On the side of the inlet 2, a new air amount 11 is enclosed which is transported in a direction toward the connecting structure 20. The first enclosed air amount 11′ has been moved forward up to a position directly ahead of its jointure with the gas volume 22, but is still separated therefrom by a first blade element 17. The enclosure of gas from the gas volume 22 in a closed volume 24′ in the expansion unit 30 analog to the volume of the gas amount 31 in the first step shown in FIG. 3 is completed. The enclosed gas amount 31 has been moved further toward the outlet 3 whereas the gas amount 31, still enclosed in FIG. 3c, has been opened and has been discharged through the outlet 3. At this point, one operating cycle of the engine 1 has been completed.

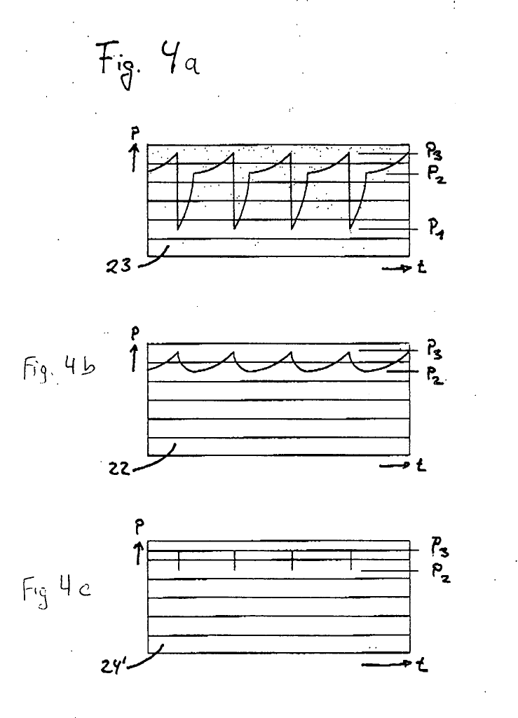

FIGS. 4a to 4c show the time-dependent pressure of the air in the air inlet area 23 (FIG. 4a), in the gas volume 22 (FIG. 4b) and in the gas outlet area 24 (FIG. 4c) for the embodiment as shown in FIG. 1. FIG. 4a shows the time-dependent pressure in the air inlet area of the gas volume 22 in the interior of the connecting structure 20 after opening of the volume of the air amount 11″ to the gas volume 22. The subsequent cycles of the periodic function refer to subsequent air amounts 11″, 11′, 11, etc.

Directly after the opening the volume of the air amount 11′ to the gas volume 23, this air volume has in the balancing zone 23 formed thereby the pressure P, which the enclosed air amount 11′ had already reached by the adiabatic compression in the compression unit 20. While the previously enclosed air amount 11″, upon its release into the air inlet area 23, is further moved toward the heating chamber 21, the pressure and temperature of the gas in the air inlet area 23 are balanced with the pressure and temperature of the gas in the gas volume 22, whereby rapidly an average pressure P₂ is established. After balancing, an isochore heating takes place by combustion of fuel in the gas volume, whereby the gas in the air inlet area 23 is heated with high efficiency and a maximum pressure P₃ is generated.

With the opening of the next blade element 17, a new inlet area 23 is formed by the opened volume of the air amount 11′, which joins the gas volume 22 and the cycle begins anew. This results in a transition-free drop of the function of the value P₃ of the gas volume 22 immediately before the opening of the volume of the air amount 11′ to the pressure P₁ of the volume of the air amount 11′ before the mixing and the balancing in the air inlet area 23.

FIG. 4b shows the pressure distribution over several cycles in the gas volume 22. The peak of the pressure P₃ corresponds with the point in time just before an air amount 11″ or 11′ joins the gas in the gas volume 22. After jointure of the air amount 11, 11′, 11″ with the gas in the gas volume 22, the gas and air are intermixed and the different pressures and temperatures are balanced so that the gas pressure in the gas volume 22 rapidly drops to a value P₂. After complete balancing with the air amount 11″ in the air inlet area 23, the gases in the gas volume 22 are heated in the heating chamber 21 and a maximum pressure P₃ is reached. With the joining of another air amount 11, the cycle begins anew.

The lowermost FIG. 4c shows the pressure distribution in the closing zone 24′ after the enclosure of a gas amount 31, 31′, 31″ in the expansion unit 30. Since enclosure of gas volumes 31, 31′, 31″ in the closing zone 24′ occurs only at the peak point of the pressure generation in the gas volume 22, the pressure in the enclosing or separating zone 24′ is always the maximum pressure P₃. The vertical lines represent the point in time when the gas amount is enclosed in the closing zone 24′.

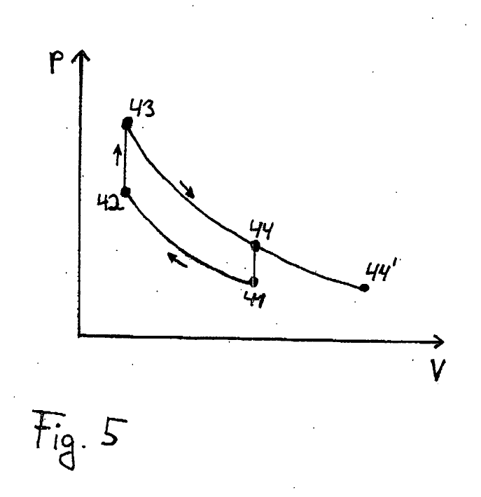

FIG. 5 shows schematically a comparison of the basic thermodynamic process of a gasoline engine and the engine according to the invention in a P-V diagram, wherein the pressure P is plotted on the y-axis over the volume V on the x-axis. In both cases, an air or gas amount is enclosed in a first volume wherein the air amount has the volume and pressure of point 41 of the diagram. The pressure at point 41 is, for example, the ambient air pressure. By moving a piston in a cylinder or by reducing the air volume in the compression unit 10 of the engine according to the invention the air amount is adiabatically compressed that is the air is compressed without addition of energy. As the volume is reduced, the pressure of the air amount is increased in accordance with the arrow directed toward the point 42.

The point 42 describes the state of highest compression in a gasoline engine. At this point a fuel air mixture is ignited whereby the temperature and the pressure increase greatly at an essentially constant volume up to the pressure as indicated by the point 43. In the embodiment of the present invention as shown in FIG. 1 at this point an enclosed air amount 11, 11′, 11″, is combined with the gas volume 22, in which combustion occurs at a constant volume whereby the temperature and the pressure are increased.

At the state indicated by the point 12 in FIG. 5, there is no volume increase for the engine according to the invention because the air from the air amount 11, 11′, 11″ is not subjected to any change in density. After mixing with the gas of the gas volume 22, the air amount 11, 11′, 11″ becomes a part of a larger gas volume 22 and represents a reference equal to the volume which the air amount 11, 11′, 11″ would have had with maximum conversion in the compression unit 10. The gas in the gas volume 22 consequently can be divided into a plurality of equal partial volumes which, because of the intermixing, all have the same properties, that is, the same temperature, pressure and density.

After the jointure of an air amount 11, 11′, 11″ having a volume as indicated by the point 42 with the gas volume 22, the air amount 11, 11′, 11″ consequently has an unchanged partial volume. Because of the intermixing with the gas volume which is under higher pressure and the heating by combustion, the air pressure of the amount is increased while the partial volume remains the same so that the point 43 is reached.

The next step of a gasoline engine resides in the increase of the gas volume by movement of the piston in the cylinder. In this step, the hot gas in the cylinder expands adiabatically as indicated by an arrow whereby the pressure drops until the point 44 is reached corresponding to the maximum displacement of the cylinder and equal the start-out volume at the beginning of the cycle at the point 41. Since compression and expansion take place in the same cylinder volume and therefore occur with the same compression and expression ratio, the gas at the point 44 has still a raised pressure in comparison with the start out point 41 so that energy is lost as the gas is discharged from the cylinder at the point 44 to return to the start out point 41.

In the engine according to the invention, the expansion ratio is greater by design than the compression ratio. As a result, the endpoint of the adiabatic expansion of the gases, which starts for a partial volume and a pressure corresponding to the point 43, is at a point 44′ which indicates a larger volume as well as a lower pressure than the endpoint 44 of the gasoline engine. The movement of the end point of the cycle from 44 to 44′ indicates an increased efficiency of the engine according to the invention in comparison for example with a conventional internal combustion engine. The utilization of the residual energy of the gas for example in a heat exchanger in the exhaust still further increases the efficiency.

The engine according to the invention and the power generation method according to the invention, permit a small engine size and lightweight engine construction with high fuel utilization that is high efficiency and therefore low operating expenses. The engine can be used in many applications for example as drive turbine for airplanes, for propeller airplanes, unmanned airborne vehicles (UAV), rocket engines, auxiliary power units in industrial applications such as drying, cooling, heat and power generation for offices, hotels, swimming pools, shopping centers and apartment complexes. Furthermore, they can be used as emergency power generators, mobile power generators for use during power peaks, as uninterrupted power sources (UPS) or a main power generators for ships, cars, trucks, buses, motorbikes, trains and similar.

What is claimed is:

1. An engine (1) comprising a compression unit (10), an expansion unit (30) and a connecting structure (20) including a gas volume (22) disposed between the compression unit (10) and the expansion unit (30), and means for supplying energy to the engine (1), the connecting structure (20) having an air inlet area (23) for receiving compressed air from the compression unit, a gas outlet area (24) for transferring gas to the expansion unit (30) and being delimited in the air inlet area (23) by the compression unit (10) and, in the gas outlet area (24), by the expansion unit (30).

2. An engine according to claim 1, wherein the connecting structure (20) has between the compression unit (10) and the expansion unit (30) an essentially constant gas volume (22).

3. An engine according to claim 1, wherein a heating device (25) is arranged in the connecting structure (20).

4. An engine according to claim 3, wherein the heating device (25) is a fuel combustion unit and comprises a fuel supply line (26) and a fuel injection nozzle (27) providing selectively for continuous and pulsed combustion of fuel.

5. An engine according to claim 1, wherein the compression unit (10) includes separate chambers for distinct air amounts (11, 11′, 11″) which are separately compressed during passage through the compression unit (10).

6. An engine according to claim 5, wherein at the end of the compression procedure a chamber including the compressed air amount (11″) is in communication with the gas volume (22) and forms part thereof.

7. An engine according to claim 6, wherein the expansion unit (30) includes separate chambers for the enclosure of distinct gas amounts (31, 31′, 31″) which are separately expanded during passage through the expansion unit (30), an expansion chamber at a time being in communication with the gas volume (22) to receive compressed gas therefrom.

8. An engine according to claim 7, wherein the gas amount (31) at the separation thereof from the gas volume (22) is about the same as the air amount (11″) upon joining the gas volume (22).

9. An engine according to claim 1, wherein a device is provided for utilizing power generated in the expansion unit (30) by the expansion of the gas volumes (31, 31′, 31″).

10. An engine according to claim 1, wherein a device is provided for driving the compression unit (10) at least a part of the energy generated by the expansion of the gas volumes (31, 31′, 31″) in the expansion unit (30).

11. An engine according to claim 7, wherein the jointure of the volumes of the compression air amounts (11, 11′, 11″) with the gas volume (22) and the separation of the volumes of the gas amounts (31, 31′, 31″) from the gas volume (22) are synchronized.

12. An engine according to claim 1, wherein the compression unit (10) comprises a first rotational element (12) provided with radial slots (16) in which first blade elements (17) are radially movably supported and disposed in contact with an inner surface (15) of a surrounding housing section (14) to form separate chambers between adjacent blade elements (17), the rotational element (12) and the housing section (14) for the air amounts being moved through the compression unit (10).

13. An engine according to claim 12, wherein one of mechanical and electrical means are provided for a rotational angle-dependent control of the radial movement of the first blade element (17).

14. An engine according to claim 1, wherein the expansion unit (30) comprises a second rotational element (31) provided with radial slots (36) in which second blade elements (37) are radially movably supported and disposed in contact with an inner surface (33) of a surrounding housing section (34) of the expansion unit (30) so as to form separate expansion chambers between adjacent second blade elements (37), the second rotational element (32) and the expansion housing section (34) for the gas being moved through the expansion unit (30).

15. An engine according to claim 14, wherein one of mechanical and electrical means are provided for a rotational angle-dependent control of the radial movement of the second blade elements (37).

16. An engine according to claim 14, wherein means are provided for one of a fixed and releasable connection between the first rotational element (12) and the second rotational element comprising one of a shaft and a V-belt drive for driving the compression unit (10) by the expansion unit (30).

17. An engine according to claim 1, wherein the compression unit (10) is provided with a pre-compression stage for the pre-compression of air supplied to the compression unit (10).

18. An engine according to claim 1, wherein the expansion unit (30) has an expansion ratio which is greater than the compression ratio of the compression unit (10).

19. An engine according to claim 1, wherein the means for supplying energy to the engine (1) is arranged in the expansion unit (30).

20. A power generating method comprising the following steps:
enclosing an air amount (11, 11′, 11″) in a compression unit (10),
compressing the air amount (11, 11′, 11″) by reducing the volume of the air amount (11, 11′, 11″) in the compression unit (10),
joining the volume of the air amount (11, 11′, 11″) with a gas volume (22) in a connecting structure (20),
mixing the air amount (11, 11′, 11″) with the gas contained in the connecting structure (20),
increasing the gas pressure in the connecting structure (20),
separating a gas amount (31, 31′ 31″) from the gas in the gas volume (22) in the connecting structure (20) and enclosing the gas amount (31, 31′, 31″) in an expansion unit (30),
expanding the gas amount (31, 31′, 31″) in the expansion unit (30) and utilizing the energy released during the expansion of the gas amount (31, 31′, 31″) in the expansion unit (30).

21. A method according to claim 20, wherein the gas pressure in the connecting unit (20) is increased by heating of the gas in the connecting unit (20).

22. A method according to claim 21, wherein the gas is continuously heated in the connecting unit (20).

23. A method according to claim 21, wherein the heating of the gas in the connecting unit (20) occurs in a pulsed manner.

24. A method according to claim 21, wherein the gas is heated in the connecting unit (20) by the combustion of fuel.

25. A method according to claim 20, wherein the mass of the air amount (11, 11′, 11″) supplied to the gas volume (22) and the mass of the gas amount (31, 31′, 31″) removed from the gas volume (22) are essentially the same.

26. A method according to claim 20, wherein the volume reduction and the opening of volume of an air amount (11, 11′, 11″) to the air inlet area (23) and the enclosing of a gas amount (31, 31′. 31″) at the gas outlet area (24) and the increase of the enclosed gas volume (31, 31′, 31″) occur about at the same time and the same rate while the combined gas volume of the air inlet areas (23), the gas volume (22) of the connecting structure (20) and of the gas outlet area (24) remains essentially constant.

27. A method according to claim 20, wherein the volumes of the air amount (11, 11′, 11″) when joining the gas volume (22) of the connecting structure (20) and the volume of the gas amounts (31, 31′, 31″) upon separation from the gas volume (22) are smaller than, that is, less than 50% of, the gas volume (22) of the connecting structure (20).

28. A method according to claim 20, wherein the gas pressure variations in the gas volume (22) of the connecting structure (20) are less than 50% of the maximum gas pressure in the connecting structure (20).
